(19) United States
(12) Patent Application Publication
(10) Pub. No.: US 2017/0330211 A1
(43) Pub. Date: Nov. 16, 2017

(54) MODELING INVENTORY PERFORMANCE FOR OMNI-CHANNEL FULFILLMENT IN RETAIL SUPPLY NETWORKS

(71) Applicant: International Business Machines Corporation, Armonk, NY (US)

(72) Inventors: Ajay Deshpande, White Plains, NY (US); Saurabh Gupta, Irving, TX (US); Arun Hampapur, Norwalk, CT (US); Alan King, South Salem, NY (US); Ali Koc, White Plains, NY (US); Yingjie Li, Chappaqua, NY (US); Xuan Liu, Yorktown Heights, NY (US); Christopher Milite, Oxford, CT (US); Brian L. Quanz, Yorktown Heights, NY (US); Chek Keong Tan, Danbury, CT (US); Dahai Xing, White Plains, NY (US); Xiaobo Zheng, Shanghai (CN)

(21) Appl. No.: 15/154,285

(22) Filed: May 13, 2016

(51) Int. Cl. G06Q 30/02; G06Q 10/08

(52) U.S. Cl. CPC G06Q 30/0206; G06Q 10/087; G06Q 30/0201

(57) ABSTRACT

A method and computer readable medium for selecting order fulfillment nodes within an order fulfillment system. The method determines one or more product-node pairs of an omni-channel order fulfillment system responsive to a received customer order. There is received for each determined product-node pair, a first input including an associated price and a price markdown rate (r) for the product. There is further received for each product-node pair, input representing a current amount of supply availability of the product (w) for a period of time in an inventory; and a first threshold value and a second threshold values defining a supply availability window of the product. The method computes an inventory performance value based on the current w, the defined supply availability window, and one or more the p and r values; and selects a node for customer order fulfillment based on the computed cost of inventory performance value.

### FIELD

The present application relates generally to computers, and computer applications, and more particularly to computer-implemented method to generate sourcing selections for omni-channel fulfillment in retail supply networks that accounts for inventory performance.

### BACKGROUND

Retailers are looking to leverage their store network along with their warehouses/Distribution Centers (DCs)/e-commerce fulfillment centers (EFCs) to fulfill omni-channel demands while profitably leveraging “enterprise inventory”.

Traditionally, order management system solutions addressed order fulfillment from 10s of nodes based on inventory availability and shipping costs. Ship from store (or pick up in store) requires rethinking the inventory availability from traditionally 10s of nodes to potentially 1000s of nodes. Order fulfillment system then needs to balance how the store inventory is utilized for fulfillment.

When store inventory is utilized aggressively for online order fulfillment, stores may be left with a little inventory for store walk-in sales. On the other hand, if the inventory is in less demand for store sales, and is not used for online order fulfillment, it is at a high risk for markdown.

Potentially, the retailer can make savings related to markdowns with online order fulfillment.

### BRIEF SUMMARY

A system and method provided for selecting eligible nodes for fulfillment based on inventory performance cost calculated for each SKU-node pair.

Inventory performance cost ensures that inventory from nodes with excess inventory at potential risk for markdown are preferred, whereas selecting inventory from nodes with low inventory is penalized and thus, preserved for potential walk-in store sales.

Thus, according to one aspect, there is provided a method for selecting order fulfillment nodes of an order fulfillment system. The method comprises: determining, at a processor device, responsive to an electronically communicated customer order for a product, one or more product-node pairs of an omni-channel order fulfillment system, each product-node pair comprising data identifying a node of the order fulfillment system having a product inventory used to fill customer orders for the product; receiving, at the processor device, for each determined product-node pair, a first input including data representing an associated price (p) value for the product, and a price markdown rate (r) value for the product; receiving, at the processor device, for each product-node pair, a second input including data representing a current amount of supply availability of the product (w) for a period of time in a product inventory maintained by the node; and receiving a specification of a first threshold (w1) and a second threshold (w2) defining a supply availability window of product for a period of time in the product inventory at the node; computing, at the processor device, an inventory performance value on the basis of the current w, the defined supply availability window, and one or more the p and r values; selecting, by the processor device, a node for customer order fulfillment based on the computed cost of inventory performance value computed for each determined product-node pair; and initiating customer order fulfillment of the product at the selected node.

In a further aspect, there is provided a system for selecting order fulfillment nodes within an order fulfillment system. The node selection system comprises: a memory storage device storing data processing instructions for selecting order fulfillment nodes; and a processor device running the data processing instructions to configure a computer system to: determine, responsive to an electronically communicated customer order for a product, one or more product-node pairs of an omni-channel order fulfillment system, each product-node pair comprising data identifying a node of the order fulfillment system having a product inventory used to fill customer orders for the product; obtain for each determined product-node pair, a first input including data representing an associated price (p) value for the product, and a price markdown rate (r) value for the product; obtain for each product-node pair, a second input including data representing a current amount of supply availability of the product (w) for a period of time in a product inventory maintained by the node; and receiving a specification of a first threshold (w1) and a second threshold (w2) defining a supply availability window of product for a period of time in the product inventory at the node; compute an inventory performance value on the basis of the current w, the defined supply availability window, and one or more the p and r values; select a node for customer order fulfillment based on the computed cost of inventory performance value computed for each determined product-node pair; and initiating customer order fulfillment of the product at the selected node.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

BRIEF DESCRIPTION OF THE SEVERAL VIEWS OF THE DRAWINGS

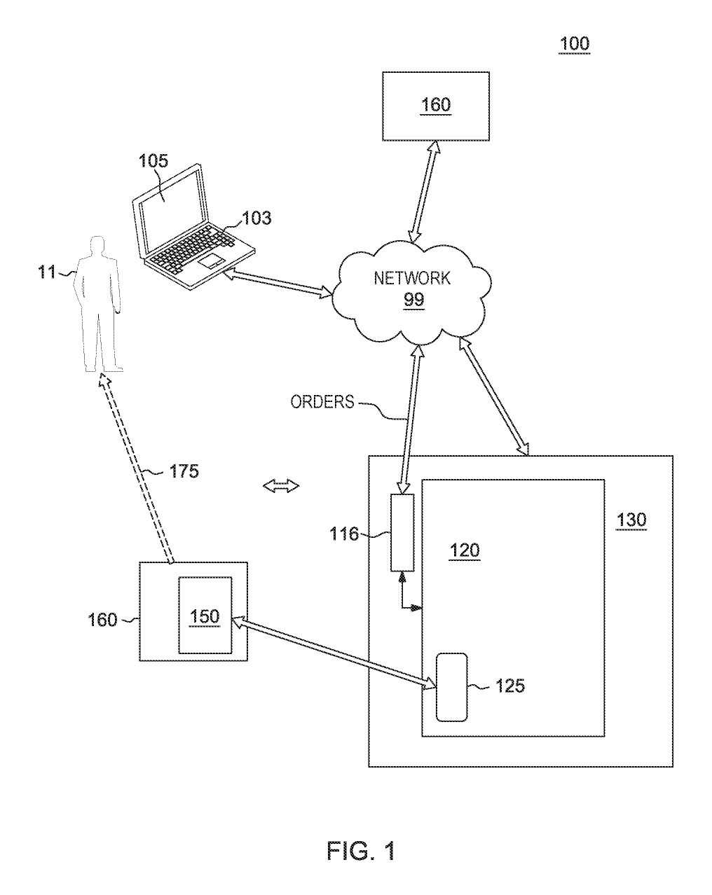

FIG. 1 is an overall system diagram of a system environment running methods described herein;

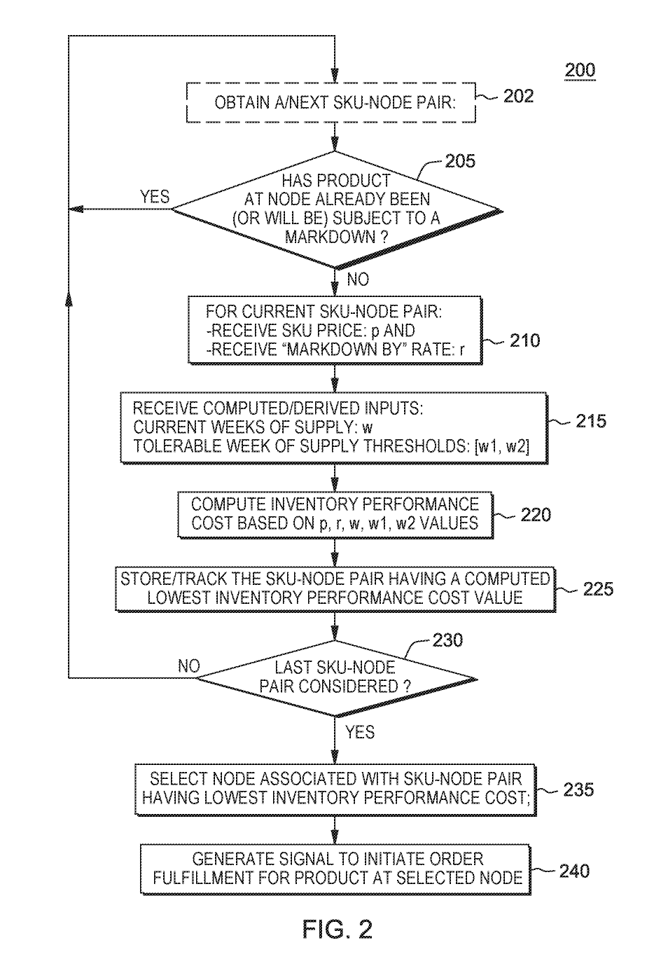

FIG. 2 is a flow diagram illustrating a method of selecting nodes in an omni-channel fulfillment system based on a inventory performance value in one embodiment of the present disclosure;

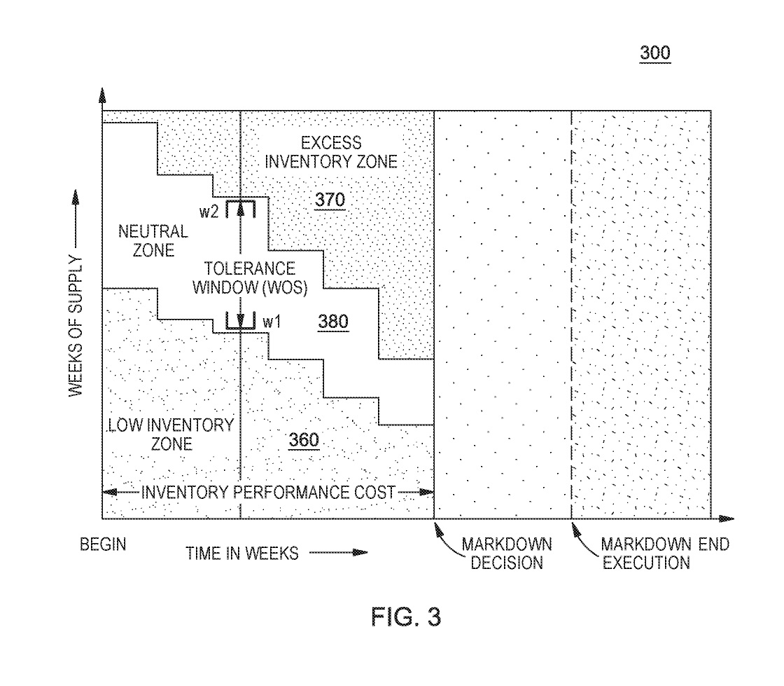

FIG. 3 is an example visualization of a plot of an availability supply of a product at a node over a period of time over time and depicting the defined supply availability window in one embodiment;

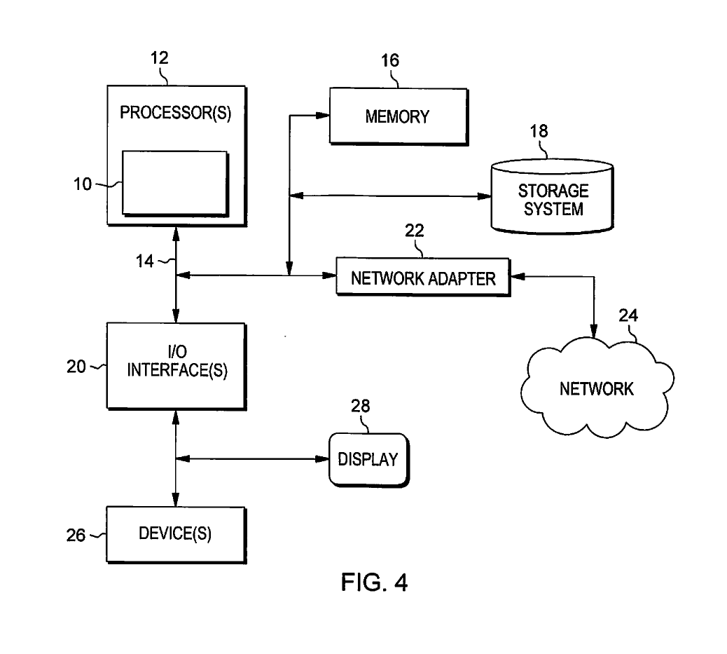

FIG. 4 illustrates a schematic of an example computer or processing system that may implement a node selection method for an omni-channel fulfillment system in one embodiment of the present disclosure.

### DETAILED DESCRIPTION

The disclosure is directed to a computer system and computer-implemented method to generate sourcing selections for omni-channel fulfillment in retail supply networks that accounts for inventory performance.

The computer system and computer-implemented method exemplifies an improvement to selecting eligible nodes for order fulfillment. While eligible nodes for order fulfillment have been typically selected based on inventory availability above certain thresholds, this has been found to potentially lead to aggressively exhausting inventory in some nodes leaving no inventory for walk-in store sales, OR if store walk-in demand is less in some nodes and if the inventory is not used for online fulfillment, the inventory will be at a high risk for markdown.

Implementing the system and computer-implemented methods described herein, eligible nodes for fulfillment may be selected based on inventory performance cost calculated for each Stock Keeping Unit-node pair (i.e., an SKU-node pair or product-node pair). As known, an SKU is a product identifier, typically of alphanumeric characters that allows a particular product to be tracked for inventory purposes and is associated with any purchasable item in an e-store or e-catalog. Computing an inventory performance cost ensures that inventory from nodes with excess inventory at potential risk for markdown are preferred to be selected for omni-channel order fulfillment, whereas selecting inventory from nodes with low inventory is penalized and thus, preserved for potential walk-in store sales.

For purposes of description, the embodiments described herein refer to data obtained at a SKU-node pair level; however, it is understood that there are situations where the data at the SKU-node level could be sparse, e.g., the inventory levels are too low or the sales are very sparse. In such situations, a week of supply (WoS) amount may indicate undue fluctuations. In these cases, instead of using data at the SKU-node level, data at the higher product hierarchy level -such as at a “style” or a “sub-class” may be used. For example, instead of using week of inventory supply for a specific SKU of small sized tight fit dark blue jeans, data for computing a WoS may instead refer to the style level of “tight fit jeans” or at the sub-class level of “jeans”. Furthermore, instead of representing a week of supply at SKU-node level, it might be possible to aggregate data across a set of nodes (e.g., such as by geographic proximity) and represent week of supply at that “cluster of nodes” level. Thus to avoid sparsity, the hierarchy level may be traversed up and/or across product or node dimension.

FIG. 1 conceptually depicts an example e-commerce retail supply network and order fulfillment system 100 that may be operated for an entity, e.g., a vendor of goods/products, and that incorporates the methods described herein for order fulfillment and inventory node selection based on a computed inventory performance cost. For purposes of description, a vendor may be an on-line, e-commerce retailer or like entity. It should be understood that the methodology herein may apply to any seller of one or more products.

An order management system 120 associated for order fulfillment is provided to enable a customer 11, through a customer device 103, e.g., a mobile device such as a Smartphone or computer device, e.g., desktop, laptop, notebook, etc., to order goods/products on-line via a customer e-commerce interface 105 which is typically a web browser capable of accessing vendor system 130 via a world wide web communications link over a network 99 (e.g., the Internet). In one embodiment, a vendor system 130 is a web-based e-commerce system configured to accept electronic orders (e.g., e-commerce orders) from a customer 11 using the interface “storefront” 116 which may be designed in any one of a number of known ways to provide functionality for customers to use customer e-commerce interface 105 to electronically place orders with one or more vendors using vendor system 130. Thus, a customer via device 103 is able to generate orders with the vendor by using e-commerce interface 105 that passes such orders to an interface “storefront” 116. Associated order management system 120 is used to process the orders. In the system shown in FIG. 1, a web-based system is used in which vendor system 130 makes web pages available using storefront 116 for display by the web browser of customer e-commerce interface 105. As will be appreciated by those skilled in the art, a single vendor may have more than one storefront and will permit more than one customer 11 to access each of the storefronts. In one embodiment, each storefront is associated with the order management system.

It is understood that the automated order management system (OMS) 120 run at vendor system 130, shown with storefront 116 in FIG. 1, may be configured to permit orders to be placed through non-web channels. For example, a customer 11 may place orders using telephone, fax, or e-mail or other retail order interfaces. Different order management systems may be used as order management system 120 and the interface capabilities of such systems may vary.

While storefront 116 and order management system 120 are depicted in FIG. 1 as grouped together and located within vendor system 130, it is understood that other implementations are possible in which storefront 116 is maintained by a third party and passes information to order management system 120 that is hosted at vendor system 130. Order management system 120 may be alternatively co-hosted remotely from vendor system 130.

The automated order management system 120 runs computer implemented methods for receiving and filling orders for products more efficiently. Such systems are implemented by order management software packages that permit a vendor to manage the supply of products to customers. Such systems typically model a supply arrangement having fulfillment centers (e.g., “nodes” 160). A fulfillment center or node 160 may be a store, a warehouse or any physical location where inventory for a vendor is located. In one embodiment, each fulfillment center has or implements an associated fulfillment system 150.

In the system embodiment depicted in FIG. 1, order management system 120 thus may further include a fulfillment center function or object 125 associated with fulfillment system 150. In order management system 120, fulfillment center object 125 represents a fulfillment center (e.g., node 160) that corresponds to fulfillment system 150. It is understood that a fulfillment center object 125 may be implemented as any suitable means for the representation of a fulfillment center in order management system 120. The information and logic contained in, and associated with, each fulfillment center object 125 may vary depending on the implementation of the order management system.

While the example system 100 of FIG. 1 shows only a single fulfillment center object 125, other examples of vendor system 130 may have multiple fulfillment center objects to represent more than one inventory storage location in the vendor's enterprise. Similarly, while FIG. 1 shows an example where fulfillment system 150 is remote from order management system 120, the two systems may be co-located such that the fulfillment system is part of the order management system.

In typical implementations, staff at the fulfillment center 160 corresponding to fulfillment system 150 may follow fulfillment instructions to package an item or product in the order and, in one embodiment, send them to an address specified in the fulfillment instructions received as depicted by broken arrow 175 directed from fulfillment node 160 to a customer 11 in FIG. 1. A confirmation of the shipment of the items may then be provided to order management system 120 by fulfillment system 150.

In one implementation, order management system 120 has a defined rule-based protocol for processing orders and communicating with fulfillment systems. In one embodiment, such order management systems implement rules to permit the vendor to determine the products available at its fulfillment centers or nodes and to arrange for required products to be supplied to its customers in response to received orders. In one aspect, the present methods described herein determine a cost of inventory performance, and the cost may be used to drive the rules order management. Further, the optimization of the total order fulfillment cost may be further driven by a combined shipping cost that may be taken into account.

In accordance with embodiment herein, a method is that may operate integrally within the OMS, e.g., as part of the order fulfillment processing flow or as provided as optional services to the OMS in conjunction with OMS order fulfillment processing. The method is used for automatically selecting nodes for order fulfillment that operates in conjunction with the protocol for processing orders. In the method for selecting nodes, a vendor or other host computer system 130 runs a program configured to model an inventory performance cost.

FIG. 2 conceptually depicts a method 200, implemented at the computer system, for modeling of inventory performance cost for an SKU-node pair in one embodiment. In particular, FIG. 2 shows the method for modeling of inventory performance cost according to a determined measure of a “tolerable” window of week of supply (WOS) for the SKU-node pair. As mentioned, it is understood that analytics described herein may be used to drive analytics at a higher product hierarchy and cluster of nodes level and which data may be used to set the week of supply at the SKU-node level.

In the method 200, the computer system receives and processes inputs associated with each SKU-node pair or, if so determined, the week of supply inventory at a higher product hierarchy level or at a cluster of nodes level. The method 200 is iterative in the sense that all SKU-node pairs in the vendor order fulfillment system having nodes with inventory for a customer-ordered product are considered. Thus, first step 202 is the computer system receiving and storing an indication of the SKU-node pair, such as data associated with or from one or more order fulfillment centers.

At 205, FIG. 2, the method determines whether for the obtained SKU-node pair, the product has been already decided for price markdown. That is, in one embodiment, the inventory performance cost is computed only if the SKU has not yet been decided for markdown. If, at 205, it is determined that the product at that node has already been decided to be subject to a markdown, then the process returns to 202 to obtain the next SKU-node pair from the system. Otherwise, if the product at that node has not been decided to be subject to a markdown, the process continues to 210 where, for that identified SKU-node pair combination, the system obtains values used in the modeling an inventory performance cost. This data may include, but is not limited to: the SKU price (p) and a “Markdown by” rate (r) which is a percentage by which a ticket price of an item may be marked down during a first markdown event.

Further, at 215, for that identified SKU-node pair combination, the system obtains, the method includes computing a second or “derived” inputs including a current week's amount of supply availability (w) for the particular product, and a computed “tolerable week” of supply (WOS) thresholds: (w1, w2). The “tolerable week” threshold data is computed as described in greater detail herein below.

In one embodiment, the method at 220 runs at the computer system to compute a cost of inventory performance value (Cost) according to:

Cost=−r*p if w>w2; (where * is a multiply operation); otherwise

Cost=p if w<w1; or

Cost=0 otherwise.

Given [w1, w2] indicating the “tolerable” window of week of supply (WOS) for a SKU-node pair: a received current week's supply availability value above threshold w2 indicates the week of supply (WOS) is very high and is at a higher risk of markdown; and a value current week's supply availability value below threshold w1 indicates the WOS is too low and as online orders are fulfilled, the particular store (node) may be potentially robbed of store sales. Having a “window” helps account for uncertainties in sales. Thus, if the SKU is not eligible for markdown, rate “r” can be zero and the model still holds.

In this manner, the system and method to model inventory performance for given SKU and node for node selection in omni-channel order fulfillment calculates an inventory performance cost value based on current week of supply, a tolerable window of week of supply—an upper and lower bound, an SKU price and an SKU markdown by rate. If WOS is computed as greater than upper bound, then there is implemented a markdown saving formula. If WOS is computed lower than a lower bound, a penalty formula is implemented. Thus, for example, an original item price p may be marked down by rate r to the new price of (1-r)*p. Thus, by avoiding potential markdown, the cost saving would be r*p.

Continuing at 225, the SKU-node pair computed inventory performance cost value is stored in an associated memory storage device. Further at 225, the method further tracks a lowest score of the SKU-node pairs subject to the Cost determining processing. Optionally, or in addition, the processed S KU-node pairs may be ranked relative to their respective computed inventory performance cost values.

In one embodiment, if it is determined that at least two or more nodes have the same computed inventory performance cost value, the nodes may be additionally ranked based on the number of units left in each node. For example, given a node having 100 units left could be preferred over the node with 50 units left. This ranking could additionally be handled in the inventory performance cost function itself where insignificant decimals are used to indicate priority. For example: given a Node 1 (100 units left) and a node 2 (50 units left) both have excess inventory with each one having inventory performance cost per unit as $−5.00. Additional units left can be incorporated in the per unit cost as: Node 1: −5−(0.01)/100=−5.0001; and Node 2: −5−(0.01)/50=−5.005.

Then, at 230, the process determines whether the current processed SKU-Node pair is the last SKU-Node pair to be considered and assigned an inventory cost value. If the current processed SKU-Node pair is not the last SKU-Node pair to be considered, the process returns to step 202 to obtain the next SKU-node pair, and receive values for computing an inventory performance cost value for the associated fulfillment center as described from steps 205-225. Otherwise, at 230, if the current processed SKU-Node pair is determined the last SKU-Node pair to be considered, the process advances to step 235 where the system selects the node having the product, as based upon its lowest inventory performance cost. In this regard, at 240, the vendor system 130 of FIG. 1 may initiate/generate a signal or message that can trigger OMS system operations to fulfill a product order at the selected node 160.

In order to compute values for the w, w1, w2 variables, reference is had to FIG. 3 which provides visualization 300 of an inventory performance cost over a product life cycle. As shown in FIG. 3, there is depicted an example plot of an estimated number of time period durations (e.g., weeks) in which an amount of inventory for a product would last at the node as shown along Y-axis as a function of time along the X-axis. Thus it is understood that for purposes of description, the thresholds w, w1, w2 represents available supply of a product in terms of weeks, however, these values may be in relation to days, or other time intervals. The visualization 300 of FIG. 3 shows how inventory performance cost varies over time. In visualization 300, there is depicted a “low inventory” zone or region 360, an “excess inventory” zone 370, and a “neutral” zone or region 380 between the excess inventory and low inventory zones. In one embodiment, the “low inventory” zone or region 360 depicts an inventory status in which an inventory performance score would be penalized for online fulfillment so as to preserve product inventory for in-store sales, whereas, the “high inventory” zone or region 370 depicts an inventory status which is preferred for online fulfillment. The neutral zone is a zone within which a tolerable window of supply measured as a difference between a first WOS value w1 and a second WOS value w2, is computed. Proceeding in time, there is reached a point at which the system decides whether to provide a price markdown and subsequently execute a markdown decision for that SKU-node pair.

In one embodiment, a computation is made to determine how to compute a week of supply “w” for a given SKU-node pair. The computing system 100 determines a value “w” according to:

w=[I+R]/z

Where I=current on-hand inventory at that node or fulfillment center, R=expected incoming inventory as receipts at that node or fulfillment center, and z=predicted average sales over a time period, e.g., weekly. In one embodiment, “w” is computed daily or weekly or on-line as the inventory updates with sales.

In one embodiment, as shown in FIG. 3, the computation of the predicted average weekly sales “z” may be based on one or more of the following information: Sales in the season (In-store and online), historical sales of similar products, price, promotions, events, regional factors and social sentiment all of which information may obtained and/or stored by retail entities, e.g., in a master database. For example, “z” may be computed simply as a past average weekly store sales over some time window if sales are not too varying, or z can be past average weekly store sales over nodes in a certain region if the sales are not too varying in a prior time period, e.g., the past few weeks.

In one embodiment, typical models may be used for demand forecasting including, but not limited to: time series analysis, regression, logistic regression, generalized linear regression, etc. For example, typical demand forecasting techniques may include those described in Forecasting aggregate retail sales: A comparison of artificial neural networks and traditional methods by Alon, I. et al., found in the Journal of Retailing and Consumer Services 8(3):147-156•April 2001, or SKU demand forecasting in the presence of promotions by Ali, Ozden Gur et al. in Expert Systems with Applications 36 (2009) pp. 12340-12348, the content and disclosure of both of which are incorporated herein by reference.

In further embodiments, a more sophisticated model is employed. For example, a demand forecasting approach may be used which may leverage one or more of: Historical sales patterns of the same or a similar product through the season; a price and current promotions; a recent sales pattern; an upcoming events and promotions; a social media sentiment about the product; and/or other regional factors such as weather or local events. For example, holiday and local calendar events can be leveraged to understand event impact. One embodiment of a demand forecasting approach may be implemented according to U.S. Ser. No. 14/556294 the content and disclosure of which is incorporated as if fully set forth herein.

The method may further implement a further model, such as by obtaining the uncertainty of prediction in the demand forecasting approach and using that to define the tolerance window. Windows of uncertainty can also be determined from looking at the distributions of current weeks of supplies for the product of nearby nodes in a region, and computing mean and standard deviations. In further embodiments, data from similar products in the past can be used.

In a further embodiment, the method run at computer system 130 further includes steps to compute a tolerable week of supply window [w1,w2] for the given SKU-node pair (or a pair at any product hierarchy level, e.g., style or sub-class). For example, [w1, w2] may be computed daily or weekly or on-line as the inventory updates with sales at that node. As an example, processes run in the system may compute:

w1=w−d1; and

w2=w+d2;

Where w−WOS, d1, d2 are fixed tolerance windows. In one embodiment, w1, w2 can be calculated as w−d1 and w+d2 respectively, where d1, d2 are some tolerance window values depending on what is the current season. In one embodiment, d1, d2 can be obtained from a number of different sources, e.g., a retailer with the knowledge of its weeks of supply may set d1 and d2 as fixed numbers depending on where it is in the season. For example, earlier in the season, d1 and d2 values might be large, e.g., 3-4 weeks, whereas as the end of the season approaches, d1 and d2 could be 1-2 weeks. An alternate approach to setting d1 and d2 could be data driven. A number of learning methods such as regression provide confidence in the output of forecast “z” (or a range). This can be used to determine d1 and d2. For example, given average weekly predicted sales is 1 that can vary in a range from 0.5 to 1.5 with +/−95% confidence. I/0.5 and I/1.5 provide w1 and w2 from which d1 and d2 are derived.

As a further example, [w1,w2] are computed according to:

w1=[I+R]/z1; and

w2=[I+R]/z2;

Where z1, z2 come from a demand forecasting model as uncertainties in prediction, e.g., where z1 assumes optimistic sales, and z2 assumes slower sales.

FIG. 4 illustrates a schematic of an example computer or processing system that may implement the optimizing inventory fulfillment balancing in an omni-channel retailing environment in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, and external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for selecting order fulfillment nodes of an order fulfillment system comprising:
determining, at a processor device, responsive to an electronically communicated customer order for a product, one or more product-node pairs of an omni-channel order fulfillment system, each product-node pair comprising data identifying a node of said order fulfillment system having a product inventory used to fill customer orders for said product;
receiving, at the processor device, for each determined product-node pair, a first input including data representing an associated price (p) value for said product, and a price markdown rate (r) value for said product;
receiving, at the processor device, for each product-node pair, a second input including data representing a current amount of supply availability of said product (w) for a period of time in a product inventory maintained by said node; and receiving a specification of a first threshold (w1) and a second threshold (w2) defining a supply availability window of product for a period of time in said product inventory at the node;
computing, at the processor device, an inventory performance value on the basis of said current w, the defined supply availability window, and one or more said p and r values;
selecting, by said processor device, a node for customer order fulfillment based on said computed cost of inventory performance value computed for each determined product-node pair; and
initiating customer order fulfillment of the product at the selected node.

2. The method as claimed in claim 1, further comprising:
tracking, for a node of each product-node pair, a current inventory level as said customer orders for said product are fulfilled over time; and
determining a time point to markdown a price of said product at said node of a product-node pair, and a subsequent time point to execute a markdown of the price of said product at said node for that product-node pair.

3. The method as claimed in claim 1, further comprising: for each product-node pair:
determining, at said processor device, whether the current amount of supply availability of said product is greater than said second supply threshold w2; and
if determined that the current amount w of supply availability is greater than said second supply threshold w2, then computing said inventory performance value according to:
−r*p (where * is a multiply operation).

4. The method as claimed in claim 1, further comprising: for each product-node pair:
determining, at said processor device, whether the current amount of supply availability of said product is less than said first supply threshold w1;
and if determined that the current amount w of supply availability is less than said first supply threshold w1, then computing said inventory performance value as p.

5. The method as claimed in claim 1, further comprising: for each for each product-node pair:
determining, at said processor device, whether the current amount of supply availability of said product is between said first supply threshold w1 and said second supply threshold w2, and
if determined that the current amount of supply availability of said product is between said first supply threshold w1 and said second supply threshold w2, then said inventory performance cost is a value of zero (0).

6. The method as claimed in claim 1, further comprising:
computing, at said processor device, said w value at a node of a product-node pair according to:
w=[I+R]/z, where I represents a current on-hand inventory at said node of said product-node pair, R represents an expected incoming inventory as receipts for sales of said product at said node, and z represents a predicted average sales of said product at said node over a time period.

7. The method as claimed in claim 6, further comprising:
computing, at said processor device, said predicted average sales “z” of said product as a function of one or more of: a level of in-store sales and online sales in the season; historical sales of similar products, one or more price, one or more promotions, events, one or more regional factors and a social sentiment of a social media network.

8. The method as claimed in claim 6, further comprising:
computing, at said processor device, said predicted average sales “z” of said product as a function of one or more of: one or more of: Historical sales patterns of the same or a similar product through the season; a price and current promotions; a recent sales pattern; an upcoming events and promotions; a social media sentiment about the product on a social media network; or other regional factors such as weather or local events.

9. The method as claimed in claim 6, further comprising:
computing, at said processor device, said w1 and w2 values according to:
w1=[I+R]/z1;
w2=[I+R]/z2;
where z1, z2 are obtained from a demand forecasting model and represent one or more uncertainties in a prediction, and where z1 is modeled in a manner assuming optimistic sales, and z2 is modeled in a manner assuming slower sales.

10. A computer readable storage medium storing a program of instructions executable by a machine to perform a method of selecting order fulfillment nodes in an order fulfillment system, the method comprising:
determining responsive to an electronically communicated customer order for a product, one or more product-node pairs of an omni-channel order fulfillment system, each product-node pair comprising data identifying a node of said order fulfillment system having a product inventory used to fill customer orders for said product;
receiving for each determined product-node pair, a first input including data representing an associated price (p) value for said product, and a price markdown rate (r) value for said product;
receiving for each product-node pair, a second input including data representing a current amount of supply availability of said product (w) for a period of time in a product inventory maintained by said node; and receiving a specification of a first threshold (w1) and a second threshold (w2) defining a supply availability window of product for a period of time in said product inventory at the node;
computing an inventory performance value on the basis of said current w, the defined supply availability window, and one or more said p and r values;
selecting a node for customer order fulfillment based on said computed cost of inventory performance value computed for each determined product-node pair; and
initiating customer order fulfillment of the product at the selected node.

11. The computer readable storage medium as claimed in claim 10, wherein the method further comprises:
tracking, for a node of each product-node pair, a current inventory level as said customer orders for said product are fulfilled over time; and
determining a time point to markdown a price of said product at said node of a product-node pair, a time point to subsequently execute a markdown of the price of said product at said node for that product-node pair.

12. The computer readable storage medium as claimed in claim 10, wherein the method further comprises: for each product-node pair:
determining whether the current amount of supply availability of said product is greater than said second supply threshold w2; and
if determined that the current amount w of supply availability is greater than said second supply threshold w2, then computing said inventory performance value according to:
−r*p (where * is a multiply operation); or
determining whether the current amount of supply availability of said product is less than said first supply threshold w1;
and if determined that the current amount w of supply availability is less than said first supply threshold w1, then computing said inventory performance value as p.

13. The computer readable storage medium as claimed in claim 10, wherein the method further comprises: for each for each product-node pair:
determining whether the current amount of supply availability of said product is between said first supply threshold w1 and said second supply threshold w2, and
if determined that the current amount of supply availability of said product is between said first supply threshold w1 and said second supply threshold w2, then said inventory performance cost is a value of zero (0).

14. The computer readable storage medium as claimed in claim 10, wherein the method further comprises:
computing said w value at a node of a product-node pair according to:
w=[I+R]/z, where I represents a current on-hand inventory at said node of said product-node pair, R represents an expected incoming inventory as receipts for sales of said product at said node, and z represents a predicted average sales of said product at said node over a time period.

15. The computer readable storage medium as claimed in claim 14, wherein the method further comprises:
computing said w1 and w2 values according to:
w1=[I+R]/z1;
w2=[I+R]/z2;
where z1, z2 are obtained from running a demand forecasting model and represent one or more uncertainties in a prediction, and where z1 is modeled in a manner assuming optimistic sales, and z2 is modeled in a manner assuming slower sales.

16. A system for selecting order fulfillment nodes within an order fulfillment system comprising:
a memory storage device storing data processing instructions for selecting order fulfillment nodes; and
a processor device running said data processing instructions to configure a computer system to:
determine, responsive to an electronically communicated customer order for a product, one or more product-node pairs of an omni-channel order fulfillment system, each product-node pair comprising data identifying a node of said order fulfillment system having a product inventory used to fill customer orders for said product;
receive for each determined product-node pair, a first input including data representing an associated price (p) value for said product, and a price markdown rate (r) value for said product;
receive for each product-node pair, a second input including data representing a current amount of supply availability of said product (w) for a period of time in a product inventory maintained by said node; and receiving a specification of a first threshold (w1) and a second threshold (w2) defining a supply availability window of product for a period of time in said product inventory at the node;
compute an inventory performance value on the basis of said current w, the defined supply availability window, and one or more said p and r values;
select a node for customer order fulfillment based on said computed cost of inventory performance value computed for each determined product-node pair; and
initiating customer order fulfillment of the product at the selected node.

17. The system as claimed in claim 16, wherein said computer system is further configured to:
track, for a node of each product-node pair, a current inventory level as said customer orders for said product are fulfilled over time; and
determine a time point to markdown a price of said product at said node of a product-node pair, and a subsequent time point to execute a markdown of the price of said product at said node for that product-node pair.

18. The system as claimed in claim 16, wherein said computer system is further configured to:
for each product-node pair:
determine whether the current amount of supply availability of said product is greater than said second supply threshold w2; and
if determined that the current amount w of supply availability is greater than said second supply threshold w2, then computing said inventory performance value according to:
−r*p (where * is a multiply operation); or
determine whether the current amount of supply availability of said product is less than said first supply threshold w1;
and if determined that the current amount w of supply availability is less than said first supply threshold w1, then computing said inventory performance value as p; or
determine at said processor device, whether the current amount of supply availability of said product is between said first supply threshold w1 and said second supply threshold w2, and
if determined that the current amount of supply availability of said product is between said first supply threshold w1 and said second supply threshold w2, then said inventory performance cost is a value of zero (0).

19. The system as claimed in claim 16, wherein said computer system is further configured to:
compute said w value for a node of a product-node pair according to:
w=[I+R]/z, where I represents a current on-hand inventory at said node of said product-node pair, R represents an expected incoming inventory as receipts for sales of said product at said node, and z represents a predicted average sales of said product at said node over a time period.

20. The system as claimed in claim 6, wherein said computer system is further configured to:
compute said w1 and w2 values according to:
w1=[I+R]/z1;
w2=[I+R]/z2;
where z1, z2 are obtained from running a demand forecasting model and represent one or more uncertainties in a prediction, and where z1 is modeled in a manner assuming optimistic sales, and z2 is modeled in a manner assuming slower sales.

21. The method of claim 1, wherein said product of said product-node pair is specified according to one of: a stock keeping unit identifier of the product, a style level of a product hierarchy, or a sub-class level of the product hierarchy.

22. The computer readable storage medium as claimed in claim 10, wherein said product of said product-node pair is specified according to one of: a stock keeping unit level identifier of the product, a style level of a product hierarchy, or a sub-class level of the product hierarchy.

23. The system as claimed in claim 16, wherein said product of said product-node pair is specified according to one of: a stock keeping unit identifier of the product, a style level of a product hierarchy, or a sub-class level of the product hierarchy.
